(19) United States
(12) Patent Application Publication
(10) Pub. No.: US 2012/0083159 A1
(43) Pub. Date: Apr. 5, 2012

(54) Three Way Light Bulb Contact

(76) Inventor: William R. Tillman, Vacaville, CA (US)

(21) Appl. No.: 12/896,167

(22) Filed: Oct. 1, 2010

(51) Int. Cl. H01K 1/46

(52) U.S. Cl. 439/614

(57) ABSTRACT

An improved contact element on a 3-way bulb that inhibits the bulb from loosening is disclosed. A special annular washer replaced the standard annular washer commonly used to connect the electrical source to the low wattage element. Rather than being a smooth washer it has a surface designed to allow the contact to move easily over the surface of the socket contact with being screwed into the socket but will provide greater friction when unscrewing the light bulbs. This will permit the user to use the light bulb until its element(s) are burned out without having to re-tighten or discard it early, mistakenly believing the low wattage element to have burned out. The new design annular contact will also create adequate friction on the socket contact's small area to clean this surface of non conductive oxides that may form over time, thereby extending the useful life of the socket switch unit.

### BACKGROUND

1. Field of the Invention

The present invention relates to the current problems experienced in the use of the 3-way light bulb in standard switch sockets.

2. Description of Related Art

Conserving resources and saving consumers money is the dual benefit of the present invention. However, the typical user of the popular 3-way lamp system is not aware that they are achieving neither when switching light bulbs on and off. This repetitive action has the unintended effect of loosening the bulb. Once loosened, users who attempt to switch the lamp to its lowest light position may find that the element does not respond and may therefore not turn on. The user often then proceeds to switch the lamp to its second lowest setting, where the lamp then uses more electricity than is necessary for the user's task. The lamp may not work on its lowest setting because once loosened electrical arcs between the contact may cause a buildup of non-conductive oxide.

Repetitive use will continue to loosen the bulb until the user will either discover the loose bulb and tighten it or will throw it away and replace it. The present invention, however, can improve this cycle by correcting the contact between bulb and lamp. The contact element is an annular washer—the low wattage element contact—and in the improved invention disclosed herein the bulb will remain tight until it actually burns out. When removing the bulb to replace it, this contact design will scrape the contact in the socket and renew its surface, thus conserving electricity and reducing the frequency with which the light bulbs and/or sockets require replacement.

### SUMMARY OF THE INVENTION

The present invention is an improvement to a conventional 3-way light bulb. With a modified contact ring that grips the low wattage element contact at the base of the bulb, the present invention allows the bulb to remain stable in its socket. 3-way light switches are the only switches which cause light bulbs to become loose due to the off center load caused by a third contact. The present invention provides the simplest solution by maintaining the integrity of the contact between the bulb and the switch. This ensures that the element will be reliably useful and both elements will remain functional without further tightening.

### BRIEF DESCRIPTION OF THE FIGURES

FIG. 1 depicts a side view of a light bulb, comprising the present invention at its base;

FIG. 2 depicts a bottom view of the preferred embodiment of the present invention, taken along viewpoint A-A in FIG. 1; and

FIG. 3 depicts a side cross-sectional view of the preferred embodiment of the contact washer of the present invention, at 10 times size relative to FIGS. 1 and 2.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

Disclosed is an improved contact element on a 3-way bulb that inhibits the bulb from loosening. This is done by providing a special annular washer commonly used to connect the electrical source to the low wattage element. Rather than being a smooth washer it has a surface designed to allow the contact to move easily over the surface of the socket contact with being screwed into the socket but will provide greater friction when unscrewing the light bulbs. This will permit the user to use the light bulb until its element(s) are burned out without having to re-tighten or discard it early, mistakenly believing the low wattage element to have burned out. The new design annular contact will also create adequate friction on the socket contact's small area to clean this surface of non conductive oxides that may form over time, thereby extending the useful life of the socket switch unit.

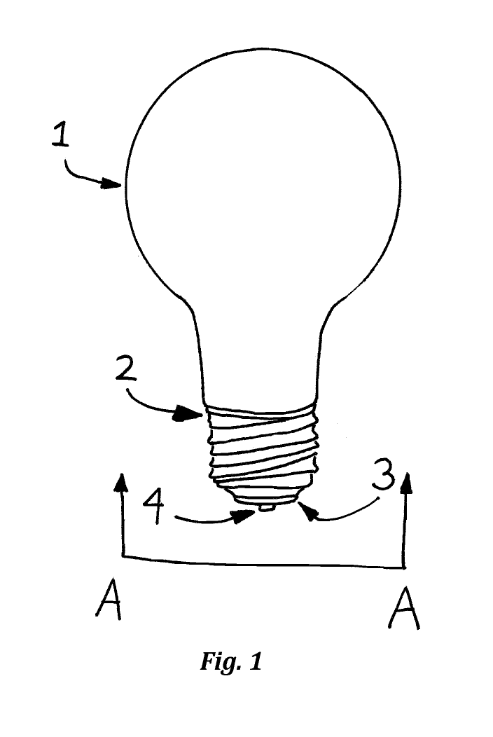

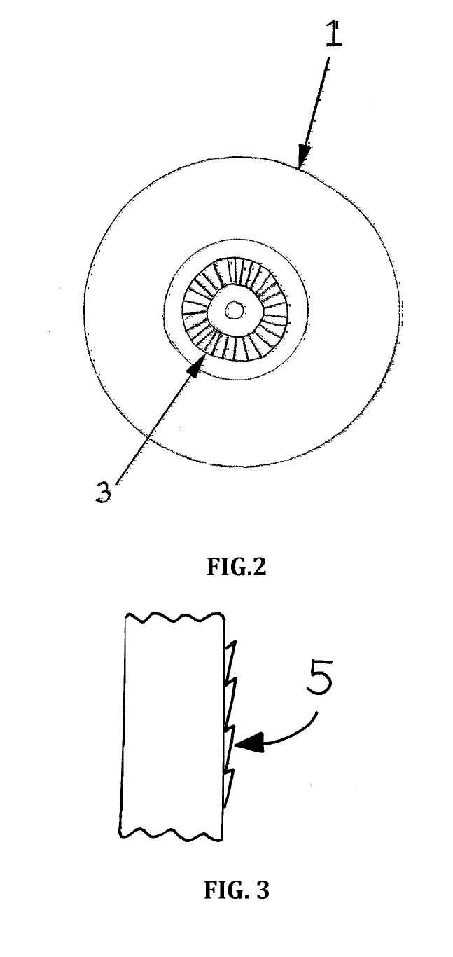

Referring first broadly to FIG. 1, the glass envelope 1 of the light bulb is depicted, as well as the metal threading of the light bulb base 2 normally connected to the neutral or white wire socket contact as installed in a lamp socket (not shown in this figure), and the improved low wattage element contact washer 3, and the center contact 4 which connects to the high wattage element.

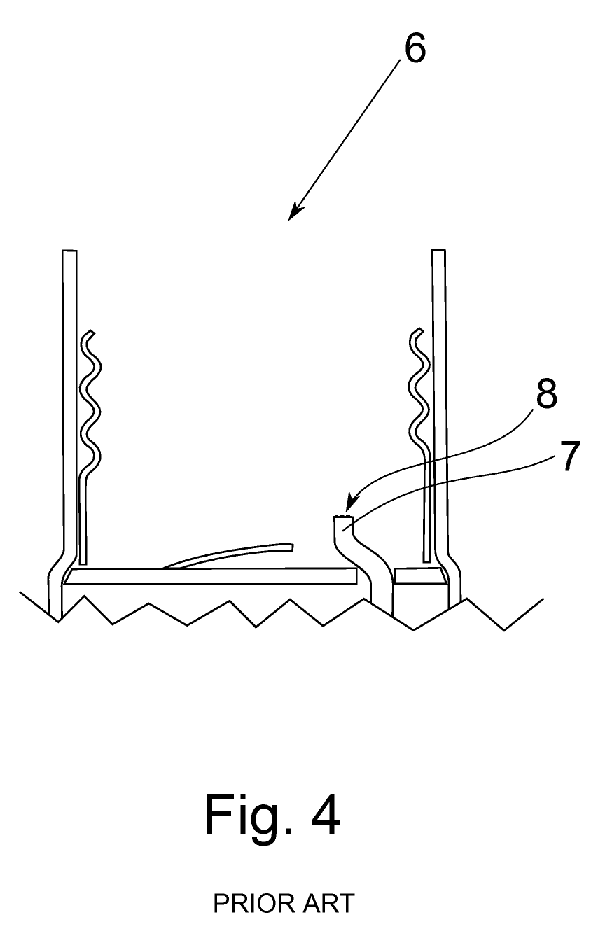

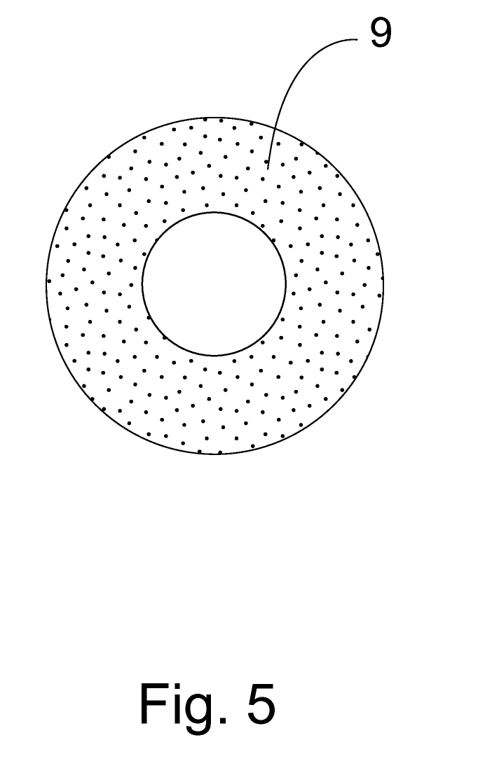

Referring next to FIG. 2, the preferred embodiment of the improved element contact washer 3 is depicted in greater detail. Conventional element contact washers currently in use feature a smooth conductive washer and are easily moved in relation to the socket contact (not shown). As depicted in FIG. 2, the improved invention comprises one-way serrations. These serrations are designed in a saw tooth orientation and therefore move easily in one direction but maintain some resistance to motion in the opposite direction. These serrations are oriented opposite the direction of twist needed for bulb installation, and thus serve the hold to bulb in place. In addition, the serrations scrape the base of the contact in the socket, thereby increasing the quality of the contact.

Insofar as the user does not have to make any change to his life, this problem solving invention is completely passive. This is an important asset, as people typically do not like change. This is simply an existing product that has been improved to better serve them. The 3-way bulb that is reliable all through its life enhances the life of the lamp socket.

In an alternative embodiment, serrations of a different type could be used, such as a fine electricity conductive grit. This design also serves to clean the low wattage element contact when the bulb is being installed and removed, thereby enhancing the life of the socket and providing reliable operation of the low wattage element.

I claim:

1. An improved light bulb base for 3-way light bulbs comprising a textured annular washer which contacts a low wattage socket contact when said improved light bulb base is mated with a 3-way light socket.

2. The improved light bulb base of claim 1 wherein said textured annular washer comprises a surface configured so as to easily permit screwing said base into said socket and so as to resist removing said base from said socket.

3. The improved light bulb base of claim 2 wherein said surface of said washer comprises one-way serrations.

4. The improved light bulb base of claim 2 wherein said surface of said washer comprises electrically conductive grit.

5. The improved light bulb base of claim 2 wherein said surface of said washer mechanically removes accumulated non-conductive material from said low wattage contact when said base is screwed into said socket or screwed out of said socket.

6. An improved contact element for a multi-brightness light blub, said contact element comprising a textured surface which contacts a socket contact in a socket when said light bulb is inserted into said socket.

7. The improved contact element of claim 6 wherein said textured surface is configured so as to easily permit screwing said light bulb into said socket and so as to resist removing said light bulb from said socket.

8. The improved contact element of claim 7 wherein said textured surface comprises one-way serrations.

9. The improved contact element of claim 7 wherein said textured surface comprises electrically conductive grit.

10. The improved contact element of claim 7 wherein said textured surface mechanically removes accumulated non-conductive material from said socket contact when said light bulb is screwed into said socket or said light bulb is screwed out of said socket.
